(19) United States
(12) Patent Application Publication
(10) Pub. No.: US 2025/0254200 A1
(43) Pub. Date: Aug. 7, 2025

(54) METHOD AND APPARATUS FOR PROVIDING SECURITY SERVICE, AND ELECTRONIC DEVICE AND COMPUTER STORAGE MEDIUM

(71) Applicants: CHINA MOBILE (SUZHOU) SOFTWARE TECHNOLOGY CO., L.T.D., Suzhou, Jiangsu (CN); CHINA MOBILE COMMUNICATIONS GROUP CO., LTD., Beijing (CN)

(72) Inventor: Ningmin SHEN, Suzhou (CN)

(73) Assignees: CHINA MOBILE (SUZHOU) SOFTWARE TECHNOLOGY CO., LTD., Suzhou, Jiangsu (CN); CHINA MOBILE COMMUNICATIONS GROUP CO., LTD., Beijing (CN)

(21) Appl. No.: 18/702,926

(22) PCT Filed: Oct. 25, 2022
(86) PCT No.: PCT/CN2022/127338

§ 371 Date: Jun. 18, 2024

(30) Foreign Application Priority Data
Oct. 27, 2021 (CN) 202111258008.4

(51) Int. Cl. H04L 9/40

(52) U.S. Cl. CPC H04L 63/20

(57) ABSTRACT

A method and apparatus for providing a security service, and an electronic device and a computer storage medium. The method comprises: creating a host security model under the constraint of a normalized sentence (S101); acquiring host information of a tenant, wherein the host information at least comprises: subscription information of a host and asset information of the host (S102); inputting the host information into the security model, so as to obtain security service information, which is output by the security model (S103); and on the basis of the security service information, providing a corresponding security service for the host of the tenant (S104). The security model is created by means of the constraint of the normalized sentence, and by using the security service information, which is output by the security model, corresponding global security services are provided for all hosts of the tenant so as to perform corresponding security prevention and reinforcement.

### CROSS-REFERENCE TO RELATED APPLICATION(S)

The present disclosure is filed based upon and claims priority to Chinese patent application No. 202111258008.4, filed on Oct. 27, 2021, and entitled “METHOD AND APPARATUS FOR PROVIDING SECURITY SERVICE, AND ELECTRONIC DEVICE AND COMPUTER STORAGE MEDIUM”, the disclosure of which is hereby incorporated by reference in its entirety.

### TECHNICAL FIELD

The present disclosure relates to the field of the computer technologies, in particular to, a method and device for providing a security service, an electronic device and a computer storage medium.

### BACKGROUND

With the popularization of computers, security incidents such as network intrusion, virus outbreak, and information leakage have become increasingly prominent. The security issue of the computer terminal has always been closely watched by various vendors and cloud service centers in the security field. At present, the security maintenance for multiple nodes in multiple resource pools under a tenant involves separate security services for each individual resource pool, which makes the tenant need to repeatedly order security services for different resource pools, and cannot provide an appropriate security service corresponding to the resource pool.

Therefore, a device capable of providing global services and providing the security service on demand is required.

### SUMMARY

The present disclosure provides a method and a device for providing a security service, an electronic device and a computer storage medium.

A first aspect of the present disclosure provides a method for providing a security service including following operations.

A host security model is created under the constraint of normalized statements.

Host information for a tenant is acquired, where the host information at least includes: order information of a host and asset information of the host.

The host information is inputted into the security model, to obtain security service information outputted by the security model.

A security service corresponding to the security service information is provided, based on the security service information, to the host of the tenant.

A second aspect of the present disclosure provides a device for providing a security service including a creating module, an acquiring module, a determining module and a providing module.

The creating module is configured to create a host security model under the constraint of normalized statements.

The acquiring module is configured to acquire host information for a tenant, where the host information at least includes: order information of a host and asset information of the host.

The determining module is configured to input the host information into the security model to obtain security service information outputted by the security model.

The providing module is configured to provide, based on the security service information, a security service corresponding to the security service information to the host of the tenant.

A third aspect of the present disclosure provides an electronic device including a processor and a memory configured to store a computer program executable on the processor.

The processor is configured to perform the operations of the method for providing the security service in the first aspect of the present disclosure when executing the computer program.

A fourth aspect of the present disclosure provides a computer storage medium, having computer executable instructions stored thereon that, when executed by a processor, cause the processor to implement the method for providing the security service in the first aspect of the present disclosure.

It is to be understood that the above general descriptions and detailed descriptions below are only exemplary and explanatory and not intended to limit the disclosure. According to the following detailed description on the exemplary embodiments with reference to the accompanying drawings, other characteristics and aspects of the embodiments of the disclosure become apparent.

### BRIEF DESCRIPTION OF THE DRAWINGS

The accompanying drawings, which are incorporated in and constitute a part of this specification, illustrate embodiments consistent with the disclosure and, together with the description, serve to explain the technical solution of the disclosure.

FIG. 1 illustrates a flowchart of a method for providing a security service in an exemplary embodiment.

FIG. 2 illustrates a flowchart of a method for providing a security service in an exemplary embodiment.

FIG. 3 illustrates a flowchart of a method for providing a security service in an exemplary embodiment.

FIG. 4 illustrates a diagram of a host security unified detection model under a cloud security center carrier service in an exemplary embodiment.

FIG. 5 illustrates a diagram of a cloud resource host security architecture in an exemplary embodiment.

FIG. 6 illustrates a multi-node-based host terminal security protection model in an exemplary embodiment.

FIG. 7 illustrates a relation diagram of a tenant using a cloud center carrier service module in an exemplary embodiment.

FIG. 8 illustrates a flowchart of a security service for a tenant in an exemplary embodiment.

FIG. 9 illustrates a structural diagram of a directed push field of a security report provided to a tenant in an exemplary embodiment.

FIG. 10 illustrates a structural diagram of a device for providing a security service in an exemplary embodiment.

### DETAILED DESCRIPTION

Various exemplary embodiments, features, and aspects of the disclosure will be described in detail below with reference to the accompanying drawings. The same reference signs in the drawings represent components with the same or similar functions. Although various aspects of the embodiments are shown in the drawings, the drawings are not required to be drawn to scale, unless otherwise specified.

Herein, special term “exemplary” means “use as an example, embodiment or description”. Herein, any “exemplarily” described embodiment may not be explained to be superior to or better than other embodiments.

In the disclosure, the term “and/or” is only an association relationship describing associated objects and represents that three relationships may exist. For example, A and/or B may represent three situations: i.e., independent existence of A, existence of both A and B and independent existence of B. In addition, the term “at least one” in the disclosure represents any one of multiple or any combination of at least two of multiple. For example, including at least one of A, B or C may represent including any one or more elements selected from a set formed by A, B and C.

In addition, for describing the embodiments of the disclosure better, many specific details are presented in the following specific implementations. It is understood by those skilled in the art that the disclosure may still be implemented even without some specific details. In some embodiments, methods, means, components and circuits known very well to those skilled in the art are not described in detail, to highlight the subject of the disclosure.

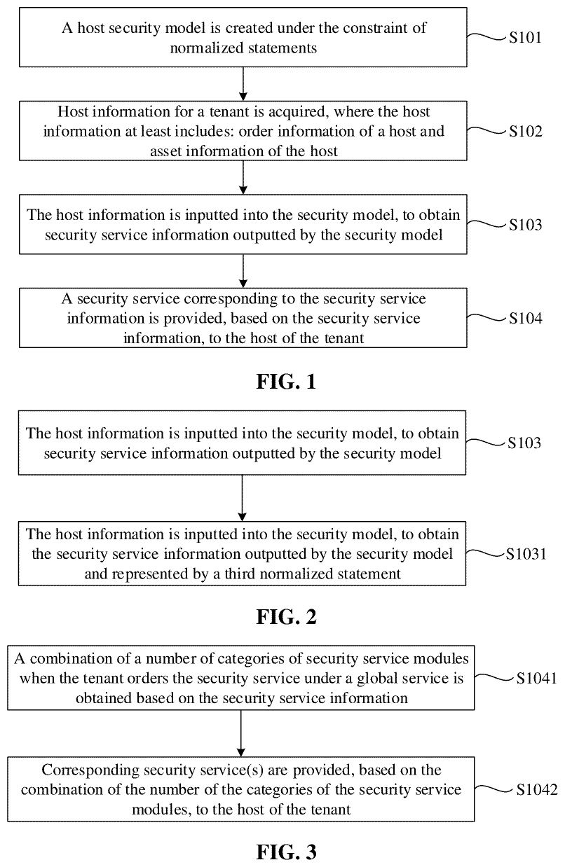

Embodiments of the present disclosure provide a method for providing a security service. With reference to FIG. 1, the method includes operations S101 to S104.

In an operation S101, a host security model is created under a constraint of normalized statements.

In an operation S102, host information for a tenant is acquired, where the host information at least includes: order information of a host and asset information of the host.

In an operation S103, the host information is inputted into the security model, to obtain security service information outputted by the security model.

In an operation S104, a security service corresponding to the security service information is provided, based on the security service information, to the host of the tenant.

In the embodiments of the present disclosure, T is a tenant, CSC is a cloud [0040] security carrier, GO is a global order, CH is a cloud host, H is a custom host, SM is a security model/security module, Lis a security service level, P is a resource pool node, and SS is a security service.

In the embodiments of the present disclosure, in the operation S101, a host security model is created under the constraint of the normalized statements. The normalized statements are formulated for the security model using the above T, CSC, GO, CH, H, SM, L, P and SS.

In the embodiments of the present disclosure, a predicate with first-order logic is used for representing the normalized statements. The first-order logic, also known as first-order predicate calculus, allows the quantification of the stated formula and is a formal system. The first-order logic is a combing logic that distinguishes from the high-order logic, and does not allow the quantification of property. The property is a characteristic of an object. The symbol ∧ represents conjunction, the symbol ∨ represents disjunction, the symbol ∀ represents universal quantifier, the symbol ∃ represents existential quantifier, the symbol → represents implication and the symbol ↔ represents double condition.

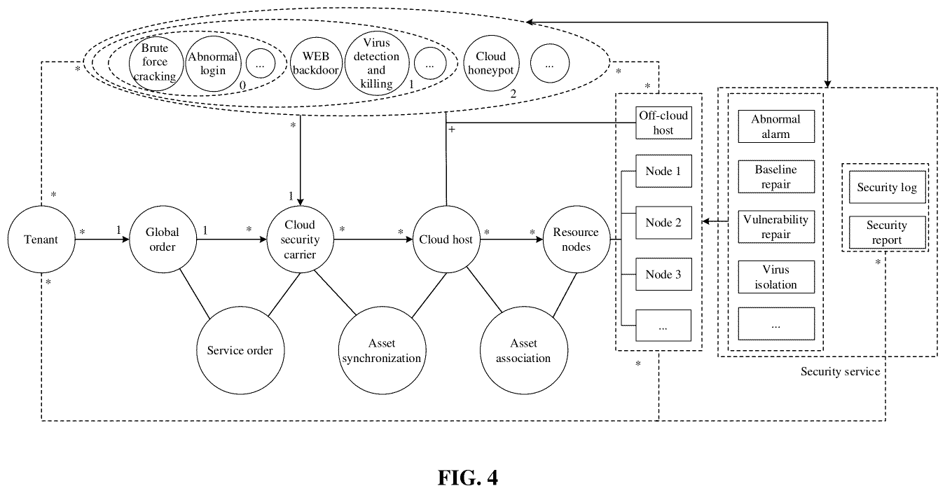

In the embodiments of the present disclosure, the cloud security center carrier provides security services to the resource pool hosts under the tenant, and uniformly manages all assets under one tenant by taking the host asset under the resource pool node and the asset of host belonging to the tenant custom category as the targets. The security modules with multiple different categories and with multiple different capabilities are integrated, by taking the tenant as the granularity, state management is performed on the host assets, different security incidents are accordingly processed and uniformly reported to the tenant as well as corresponding alarms are issued. In the carrier service center, the data of all tenants is collected, stored and log reported uniformly. The tenant may only needs to simply order the registration carrier service once to implement the decoupling from the resource pool node, and use the corresponding security capabilities on demand. Please refer to FIG. 4 which is a diagram of a host security unified detection model under a cloud security center carrier service.

In the embodiments of the present disclosure, as illustrated in FIG. 4, after the tenant orders the global service once, the cloud security center carrier acquires the assets of the cloud host and/or the off-cloud host, and according to the change in the assets of the hosts, synchronously updates the asset information of the hosts in the cloud security center carrier.

In the embodiments of the present disclosure, the host security model is created under the constraint of the normalized statements, the normalized statement indicates the host information of the user. After the order information and the asset information included in the host information are inputted into the security model, representations of the normalized statements of the host information are generated; and the security model outputs security service information according to the representations of the normalized statements. The cloud security center carrier provides, based on the security service information, corresponding security services to the host of the tenant.

In the embodiments of the present disclosure, the security model in the operation S101 means a set of security services with the security service levels corresponding to the prevention and reinforcement possessed by the cloud host assets and the off-cloud host assets under the condition of the global order by the tenant. For the cloud host assets, it includes a summary of the security capabilities possessed by all hosts under multiple resource pool nodes, i.e., single or multiple security sub-capabilities form corresponding security service associations on single or multiple hosts. For the off-cloud host assets, under the premise of tenant custom management, a service mapping relationship is formed with the corresponding security sub-capabilities.

In the embodiments of the present disclosure, in the operation S102, the order information of the host includes, but is not limited to, a level of a security service ordered by the tenant for the host, and whether the tenant orders a global service for the host.

In the embodiments of the present disclosure, the higher the level of the security service, the greater the number of categories of security services.

In the embodiments of the present disclosure, the categories of security services include, but are not limited to: a detection and an alarm for brute force cracking and an abnormal login, maintenance of WEB backdoor security, virus detection and killing, maintenance of cloud honeypot data, an abnormal alarm, a baseline repair, a vulnerability repair, a virus isolation and other measures; and the security log and security report are generated.

In the embodiments of the present disclosure, in the operation S103, after the order information and the asset information included in the host information are inputted into the security model, the security service information outputted by the security model is obtained. Herein, the security service information indicates whether the tenant orders the global service. If the tenant orders the global service, a combination of security service modules selected by the tenant is outputted for the assets to be maintained, under the ordered global service.

In the embodiments of the present disclosure, in the operation S104, the security service corresponding to the security service information is provided, based on the security service information, to the host of the tenant, which refers to that based on the security service information outputted by the security model, corresponding categories of the security service(s) are provided to the host of the tenant.

In the embodiments of the present disclosure, the host security model is created under the constraint of the normalized statements; the host information is inputted into the security model, to obtain the security service information outputted by the security model; and the security service corresponding to the security service information is provided, based on the security service information, to the host of the tenant. Compared with the existing technology where a single security service order is performed for a single resource pool (the single resource pool is independent, has no statistical security capability, and cannot provide appropriate global security services on demand), the security model in the embodiments of the present disclosure can output the security service information based on the order information and the asset information of the host of the tenant, and provide corresponding security services to the host of the tenant on demand.

In the embodiments of the present disclosure, the operation that the host information is inputted into the security model includes: the order information represented by a first normalized statement is input into the security model; and/or, the asset information represented by a second normalized statement is input into the security model.

In the embodiments of the present disclosure, the first normalized statement represents a level of an ordered service and whether the global service is ordered in the order information.

In the embodiments of the present disclosure, the first normalized statement specifies the attribute feature L and GO value range relationship. Li represents the i-th level, and the levels are sequenced in order of size, and Li⊆Lj(i<j) represents that the security service modules at j-th level include the security service modules at the i-th level. GO^{0/1} represents whether the tenant orders the global service, where 0 represents that the tenant does not order the global service and 1 represents that the tenant orders the global service.

In the embodiments of the present disclosure, the second normalized statement represents a combination of the asset information.

In the embodiments of the present disclosure, the cloud host assets under multiple nodes and the off-cloud host assets are combined to form all the hosts assets under the tenant, which may be represented as P₁∧P₂∧P₃ . . . . Pₚ(p>0)∈CH+H, CH∪OH, where P represents the cloud host asset corresponding to the p-th node.

In the embodiments of the present disclosure, the order information is represented by the first normalized statement, and the asset information is represented by the second normalized statement. The order information represented by the first normalized statement is inputted into the security model, and the asset information represented by the second normalized statement is inputted into the security model, so that the order information and asset information for the tenant may be integrated, and security services may be provided to the tenant according to the actual requirements of the tenant.

In the embodiments of the present disclosure, the order information at least includes: a value of Global Order (GO) constraining whether the tenant orders a global service, where if the value of the GO is a first value, indicating that the tenant orders the security service, and if the value of the GO is a second value, indicating that the tenant does not order the security service; and a value of Ln constraining a level of the security service ordered by the tenant, where n represents that the security service ordered by the tenant belongs to a n-th level, and n is configured to determine the number of categories of modules providing the security service.

In the embodiments of the present disclosure, for the value of the GO constraining whether the tenant orders the global service, if the value of the GO is the first value, it indicates that the tenant orders the security service; and if the value of the GO is the second value, it indicates that the tenant does not order the security service. Herein, the first value is different from the second value, and if the tenant does not order the global security service, then the tenant cannot use the global security service provided by the cloud security center carrier.

In the embodiments of the present disclosure, the first value may be taken as 1, and the second value may be taken as 0.

In the embodiments of the present disclosure, for the value of Ln constraining a level of the security service ordered by the tenant, n represents that the security service ordered by the tenant belongs to the n-th level, and n is configured to determine the number of the categories of the modules providing the security services. Herein, the levels n are sequenced in order of size, and the higher the level, the greater the value of n, and the greater the number of categories of the modules providing the corresponding security services.

In one embodiments, in case that n=i, the security service level is Li; and in case that n=j, the security service level is Lj. Li⊆Lj(i≤j) represents that the modules providing the security service at the j-th level include the modules providing the security service at the i-th level.

In the embodiments of the present disclosure, the value of the GO represents whether the tenant orders the global service; and the value of the Ln represents the level of the security service ordered by the tenant and further represents the security service module(s) that the tenant needs to order. Whether the global service is provided may be determined according to the needs of the tenant, and the categories of the security service module(s) selected by the tenant may be determined according to the level selected by the tenant under the global service. In this way, the security service may be provided for the tenant on demand, by the normalized statement constraining the attribute that represents the order information of the tenant.

In the embodiments of the present disclosure, the asset information includes: a set of assets of multiple hosts to be maintained.

In the embodiments of the present disclosure, the asset information is the cloud host asset information and the off-cloud host asset information corresponding to the multiple nodes under the tenant, and Pₚ represents the host asset corresponding to the p-th node.

In the embodiments of the present disclosure, the set of the assets of the multiple hosts to be maintained is represented by the symbol P₁∧P₂∧P₃ . . . . Pₚ(p>0)∈CH+H, CH∪OH, which represents that the conjunction of the host assets corresponding to the multiple nodes constitutes the set CH+H of the assets of the multiple hosts.

In the embodiments of the present disclosure, for the conjunction of the assets of the multiple hosts, even if the assets of the multiple hosts are combined into a set, each host is labeled independently of each other, which is convenient for distinguishing and identifying the multiple hosts later, and providing the security services to the hosts.

In the embodiments of the present disclosure, the asset information of the host is required to be determined, in order to determine the maintenance object of the host by the security service, which facilitates the detection and maintenance of security service for these assets of the host, so that the corresponding security services may be provided for the host.

In the embodiments of the present disclosure, with reference to FIG. 2, the operation that the host information is inputted into the security model, to obtain the security service information outputted by the security model further includes an operation S1031.

In the operation S1031, the host information is inputted into the security model, to obtain the security service information outputted by the security model and represented by a third normalized statement.

In the embodiments of the present disclosure, the third normalized statement is that security capabilities with different types constitute security modules, and the multiple security modules form a security service through the capability orchestration, which is represented by the symbol (SM₁∧SM₂∧SM₃∧SM . . . SMₜ)→SS^{l}|l>0, t>0, where SMₛₘ is the sm-th security sub-capability corresponding to the designated category of security module. The above symbol represents that a set formed by the conjunction of the multiple security sub-capabilities constitutes modules for security service SS^{l} at the L-th level.

In the embodiments of the present disclosure, different tenants have different security capability services according to whether the tenants perform the global order. SS¹⊂SS² . . . ⊂SS^{l}|l>0 represents that under the condition of l>0, the security service SS^{l} with the l-th level contains the security sub-capability modules at the l−1-th level, and so on, and the security service modules at the higher level contain the security service modules at the lower level.

In the embodiments of the present disclosure, the host information is inputted into the security model, to obtain the security service information outputted by the security model and represented by the third normalized statement, which means that the order information and asset information indicated by the host information are inputted into the security model, and the security model uses the third normalized statement to represent the combination of categories of the corresponding security service modules provided to the tenant as the security service information outputted by the security model and represented by the third normalized statement. In this way, the required and corresponding security services can be provided for the tenants.

In the embodiments of the present disclosure, with reference to FIG. 3, the operation that the corresponding security service is provided, based on the security service information, to the host of the tenant includes operations S1041 and S1042.

In an operation S1041, a combination of a number of categories of security service modules in a case that the tenant orders the security service under the global service is obtained based on the security service information.

In an operation S1042, a corresponding security service is provided, according to the combination of the number of the categories of the security service modules, to the host of the tenant.

In the embodiments of the present disclosure, a model formula of the security model is: T=SS_{GO=1}^{l}↔(Σₗ^{p}CH+H)Σₗ^{sm}SM|∃l, Σₗ^{sm}⊆SS^{l} (l>0).

Herein, T represents the tenant, l represents the corresponding security service level, GO=1 represents that the tenant performs the global order, CH represents the cloud host, P is the number of the resource pool nodes, H represents the off-cloud host asset, SM represents the security service sub-capability, and sm represents the number of multiple security sub-capabilities.

The meaning of the above model formula is the set SS^{l} of the security service modules corresponding to the security service level l corresponding to the asset of the cloud host CH and the asset of off-cloud host H under the condition that the tenant T orders the global service (GO=1).

In the embodiments of the present disclosure, in the above model formula, T=SS_{GO=1}^{l}, represents that the tenant T orders the security service under the global service, (Σₗ^{p}CH+H) represents the set of the host assets to which the nodes 1 to p belong, Σₗ^{sm}SM represents the set of 1 to sm security sub-capability services SM, and ∃l, Σₗ^{sm}SM⊆SS^{l} (l>0) represents that the security service level l is greater than 0, and the set of 1 to sm security sub-capabilities belongs to the security service corresponding to the security service level l. In general, the meaning of the above-mentioned formula of the security model is that the security service SS required by the tenant Tis the security service SS^{l} corresponding to the level l which is provided to the tenant T and formed according to the combination of the number of categories of the security service modules for the set CH+H of the host assets to which 1 to p nodes belong, under the condition that the tenant orders the global service, the security service level l is greater than 0 and the set of 1 to sm security sub-capabilities belongs to the security service corresponding to the security service level l.

In the embodiments of the present disclosure, the corresponding security services are provided to the host of the tenant according to the combination of the number of the categories of the security service modules, so that the security services required by the tenant may be provided to the tenant.

In the embodiments of the present disclosure, the cloud security center carrier may synchronously update the assets of the hosts in the cloud security center carrier according to the change in the assets of the hosts for the tenant. After the synchronization of the assets of the hosts is completed, the cloud security center carrier will generate the security service SS corresponding to the tenant by using the security model based on the inputted the security service level and the corresponding security service module(s) in combination with the assets of the hosts under the tenant.

In the embodiments of the present disclosure, after it is determined that the corresponding security services SS are provided to the tenant, the cloud security center carrier will generate an installation command for a terminal engine component that uniquely identifies the tenant, and send it to each host for automatic or manual installation. After the installation is completed, the backend thread of the host automatically establishes a communication link with the security center carrier. After the security service is started, the security center carrier starts the security engine thread to firstly detect the host system state, the security configuration, and firewall; obtains rule bases such as baselines, vulnerabilities, risks, and viruses from the central carrier service; and performs security detection based on the rule information. If corresponding risk items are detected, based on the levels of the risk items including a low-risk level, a medium-risk level and a high-risk level, combined with the repair measures configured by default or the standards set by the tenant on the platform, whether to repair the risk items are determined to implement the security reinforcement, and an alarm is automatically triggered to notify the tenant of relevant data information in time. The dependent files or security configurations required to be reinforced are automatically pulled from the central carrier service.

In the embodiments of the present disclosure, under the definition of corresponding security rules, the security engine thread may automatically monitor external intrusion traffic, such as the brute force cracking, and the abnormal login, and form a set of virtual security walls for the host terminal operations initiated by non-tenants themselves, so as to implement the terminal security prevention.

In the embodiments of the present disclosure, the tenant logs into the cloud security center carrier, orders the security service under the global service, and obtains the capability services with the corresponding specification. In this way, the global and centralized security detection and reinforcement may be performed on the hosts corresponding to multiple nodes under the tenant. Moreover, according to the order information and asset information of the host under the tenant, corresponding and appropriate security services are provided to the tenant according to the requirements of the tenant.

The following examples are provided with reference to the above embodiments.

For the first example, a method for providing a security service.

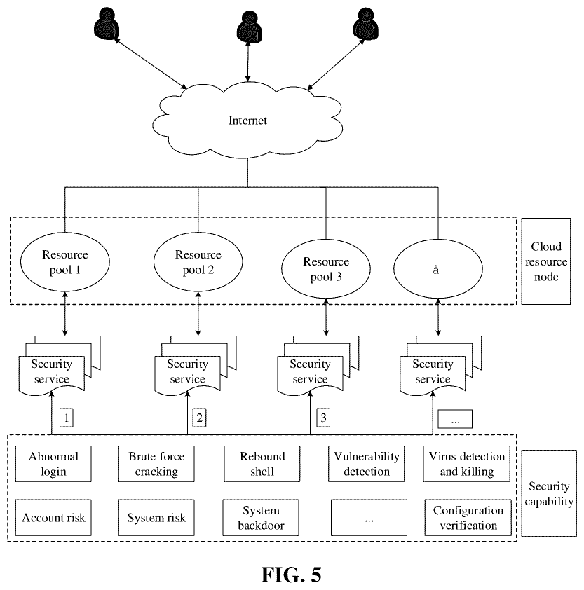

In the existing technology, with the popularization of the use of computers in human life, security incidents such as the network intrusion, the virus outbreak, and the information leakage are becoming increasingly prominent. Security issue of the computer terminal has always been closely watched by various vendors and cloud service centers in the security field. The essence of the security issues of computer terminals is that in the operating environment of the computer terminal, including physical environment, network environment or virtual environment, a part of the service or the whole service of the terminal is unavailable due to the intrusion of external attack event or the impact of its own component vulnerabilities. In the solution for the security issues of the terminal, it may be divided into the security protection for the single terminal or the security protection for the cloud terminal based on the size of the client granularity. In the environment of the public cloud market, the differences in the user's geographical location and the impact of service performance are considered, multiple sets of security protection across different locations are provided for the client hosts of the cloud service, and the security detection and reinforcement suggestion corresponding to the host to which each resource pool belongs are reflected at different nodes. With reference to the diagram of the cloud resource host security architecture illustrated in FIG. 5, based on the number of deployed nodes and the influence of network bandwidth, each resource pool has the same, independent, and non-statistical security capabilities.

For the security detection, protection and reinforcement for security of the single resource pool cloud host, the targeted services are provided based on the characteristics of the distribution of the assets of the user hosts. In the case where the same tenant or user applies for asset protection, the tenant or user needs to perform multiple orders and multiple resource operations. In this way, certain repetitive events may occur in the use of cloud security capabilities, and for the security reinforcement, it is also necessary to independently process single-point resource pool host assets, as the multi-node-based host terminal security protection model illustrated in FIG. 6. For cloud security capability providers, at the aspect of security capability output, multiple regional security core clusters are required to be deployed simultaneously to correspond to all resource nodes covered by the tenant. Moreover, on the side of the security capability, if the same security vendor does not have strong security protection capability, such as the virus detection or the cloud killing in anti-virus, the brute force cracking, the abnormal login, the rebound shell, the cloud platform configuration, the virus detection and killing, it is necessary to provide different capabilities of security modules independently and separately.

In the existing multi-resource pool node host terminal security model, the assets of the user host correspond to the resource pool nodes, provided security capabilities are associated with the resource pool nodes, and there are one or more independent security clients for the host terminal security, so that in the case where the tenant uses the cloud security protection capabilities, there are the separability for the assets of the host, the repeatability for product order, and the diversity of the security capability terminal protection processes. This is a node distribution-based security capability architecture model, and it has resource node independence in resource deployment and security data analysis, and is a non-global unified model.

The existing multi-node-based host terminal security protection has the following disadvantages in use.

For the first disadvantage, when the security detection, protection and reinforcement is performed on the assets of the hosts for the single tenant, the product functions may be ordered and used one by one by taking the resource pool node as the unit, which causes the repeatability and redundancy in terms of the usage of the security capability by the tenant. If the user needs to use different terminal security protection capabilities, the user needs to manually pull up multiple processes on the assets of the hosts, which causes certain complexity in operations of the user and poor user experience.

For the second disadvantage, in the case where the user counts the security states of the assets of the hosts, the same security incident report reported by multiple resource pool nodes cannot be detected and processed in a centralized manner. If an alarm threshold or a security whitelist are required to be set for the attack item, it is also necessary to maintain multiple thresholds or multiple whitelist lists, which may be difficult to implement consistent processing for the security prevention and reinforcement of the assets of the hosts for the user.

For the third disadvantage, in the multi-node security protection capability, for cloud security capability providers, asset data of the tenant cannot be managed centrally, and the security capability cluster center deploys the resources at each independent resource pool node, which adds multiple times the operation and maintenance cost on the unified management of cluster resources and the unified monitoring of service operation states. Moreover, in the case where the security detection data is processed, unified security processing and security report statistics cannot be performed from the dimension of the tenant.

The embodiments of the present disclosure implement a global, centralized, and cloud processing security detection and reinforcement method for the tenant host assets, so that all security incidents are processed by uniformly taking the tenant as the granularity, and the ability to dynamically expand exists for the newly added resource pool node, the newly added host asset, and the newly added security protection capability. The tenant does not need to repeatedly order or operate the related product, and the unified security detection is performed on all the host assets under entire resource pool nodes. Moreover, on the side of the cloud security capability, a security capability center cluster is provided to manage the asset states of the hosts for all tenants, and perform unified analysis and processing on security data, thereby ensuring consistency in the host security state detection, reinforcement and alarm. Moreover, at the aspect of the resource management, the complexity of cluster management and the maintenance cost of operation and maintenance personnel are also reduced. Furthermore, corresponding security services are provided according to the requirements of the tenant.

The embodiments of the present disclosure propose a unified detection method for the security of the hosts under the security center carrier service. According to the method, all host assets under a tenant are managed uniformly with the host assets under the resource pool node and the host assets belonging to the user custom category being taken as the targets. The security modules with multiple different categories and multiple different capabilities are integrated, by taking the tenant as the granularity, the state management is performed on the host assets, different security incidents are accordingly processed and uniformly reported to the tenant, and an alarm corresponding to each security incident is sent. In the carrier service center, the data of all tenants is collected, stored and log reported uniformly. The tenant only needs to simply order the registration carrier service once to implement the decoupling from the resource pool node, then the tenant may use the corresponding security capabilities based on requirements. The operations of the model refer to the host security unified detection model under the cloud security center carrier service illustrated in FIG. 4.

T is the tenant, CSC is the cloud security carrier, GO is the global order, CH is the cloud host, H is the custom host, SM is the security model/security module, L is the security service level, P is the resource pool node, and SS is the security service. The following formulates some semantic constraint specifications for the unified access model, which are represented by first-order predicate logic. The symbol ∧ represents conjunction, the symbol ∨ represents disjunction, the symbol-represents universal quantifier, the symbol ∃ represents existential quantifier, the symbol → represents implication. The specifications are agreed as follows.

For the first specification, the attribute feature L and GO value range relationship are agreed. Lᵢ(i>0) represents the i-th level, and the levels are sequenced in order of size, and Li⊂Lj(i<j) represents that the security service capability modules at j-th level include the security service capability modules at the i-th level. GO^{0/1} represents whether the tenant orders the global service, where 0 represents that the tenant does not order the global service and 1 represents that the tenant orders the global service.

For the second specification, the cloud host assets under multiple nodes and the off-cloud host asserts are combined to form all host assets under the tenant, which may be represented as P₁∧P₂∧P₃ . . . Pₚ(p>0)∈CH+H, CH∪OH, where P represents the corresponding cloud host asset under the p-th node.

For the third specification, security capabilities with different types constitute security modules, and the multiple security modules form a security service through the capability orchestration, which is represented by the symbol (SM₁∧SM₂∧SM₃∧SM . . . SMₜ)→SS^{l}|l>0, t>0, where SMₛₘ is the sm-th security sub-capability corresponding to the designated category of security module. Depending on whether to perform the global order, different tenants have different security capability services, SS₁⊂SS₂ . . . ⊂SSₗ|l>0.

Based on the defined first to the third specifications above, it is achieved that the cloud security capability detection and reinforcement is performed on the host assets under different nodes and different custom host assets by the multiple tenants in the cloud center carrier service, The model formula is as follows.

$$T = S {S}_{GO = 1}^{l} ↔ ( {\sum }_{1}^{p} C H + H ) {\sum }_{1}^{s m} S M \vert ∃ l , {\sum }_{1}^{s m} S M ⊆ {SS}^{l} ( l > 0 )$$

Where T represents the tenant, l represents the corresponding service level, GO=1 represents that the tenant performs the global order, CH represents the cloud host, P represents the number of the resource pool nodes, H represents the off-cloud host asset, SM represents the security service sub-capability, and sm represents the number of multiple security sub-capabilities.

The meaning of the above formula model is a set of security services with the security service levels corresponding to the prevention and reinforcement possessed by the cloud host assets and the off-cloud host assets under the condition of the global order by the tenant. For the cloud host assets, the security capabilities possessed by all hosts under multiple resource pool nodes are summarized, i.e., single or multiple security sub-capabilities form corresponding security service associations on single or multiple hosts. For the off-cloud host assets, under the premise of tenant custom management, a service mapping relationship is formed with the corresponding security sub-capabilities.

After the synchronization of the host assets of the tenant is completed in the cloud center carrier service, the center service analyzes and counts the level of the security service and the corresponding security sub-capabilities to generate the installation command for the terminal engine component that uniquely identifies the tenant, and the command is automatically distributed, through the form of the public network or proxy service, to each terminal for automatic installation or the tenant manually obtains it from the platform side for self-installation. After the installation is completed, the backend thread of the host automatically establishes a communication link with the center carrier service. After starting, the thread firstly detects the host system state, the security configuration and firewall; obtains rule bases such as baselines, vulnerabilities, risks, and viruses from the central carrier service; and automatically performs security detection based on the rule information. If corresponding risk items are detected, based on the levels of the risk items including a low-risk level, a medium-risk level and a high-risk level, combined with the repair measures configured by default or the standards set by the tenant on the platform, whether to repair the risk items are determined to implement the security reinforcement, and an alarm is automatically triggered to notify the tenant of relevant data information in time. The dependent files or security configurations required to be reinforced are automatically pulled from the central carrier service. For the security prevention of the host, under the definition of corresponding security rules, the security engine thread may automatically monitor external intrusion traffic, such as the brute force cracking, the abnormal login, and form a set of virtual security walls for the host terminal operations initiated by non-tenants themselves, so as to implement the terminal security prevention.

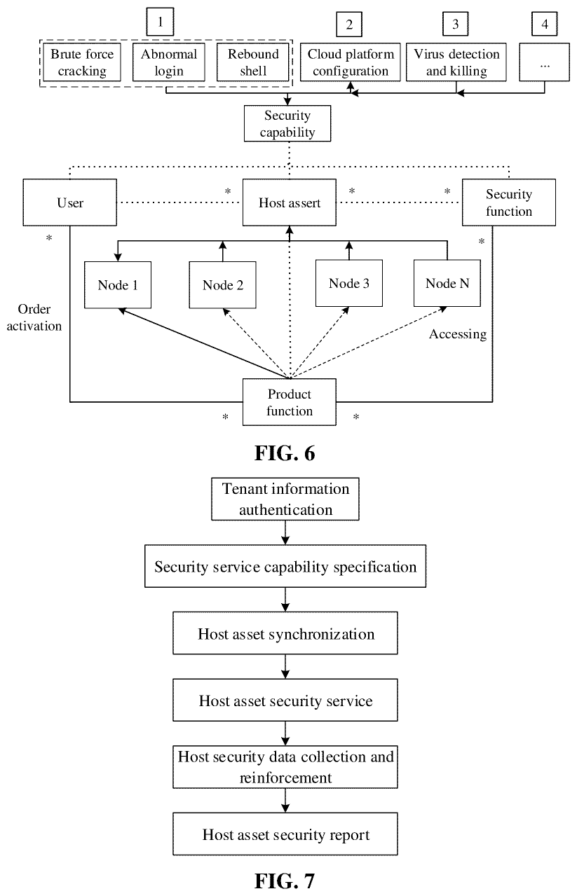

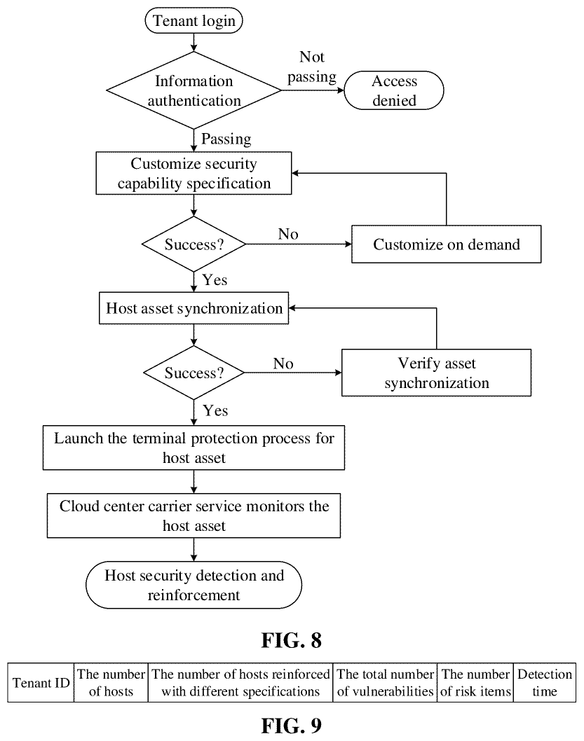

When the tenant wants to order, the tenant logs into the cloud platform, performs the global order on the cloud capability product, and obtains capability services with corresponding specifications, so as to perform the global and centralized security detection and reinforcement on cloud hosts under multiple nodes and the off-cloud host, as illustrated in FIG. 7 showing the relation diagram of a tenant using a cloud center carrier service module.

The tenant security service flowchart corresponding to the operations of using the service is illustrated in FIG. 8.
1. The tenant logs into the cloud platform and passes the authentication.
2. The corresponding security service satisfying the conditions is selected, and the level of service is determined.
3. The cloud host and the off-cloud host are pre-collected to form a list of assets of the hosts of the tenant in the initial state. When the host information changes or the host resource is unordered, the asset data of the host is required to be updated in time, and the changes in the assets is required to be regularly synchronized in the later period.
4. A link for mutual access between the host terminal and the cloud center carrier service is established, and the security service module is started.
5. The cloud center carrier service uniformly collects and monitors the security data of all node hosts, outputs the alarm, automatically reinforces, and provides the repair suggestion.
6. A unified security report is formed for the security monitoring data of all tenants and all assets, and is pushed regularly to the operation and maintenance personnel to check.

In the case where the tenant uses the cloud center carrier service through the cloud platform, a large number of security logs may be generated. Based on the operating state and event analysis of assets of the tenant, the standard push notification and security statistical report are formed, so that the tenant may prevent in advance on the premise of state awareness. As illustrated in FIG. 9, the field for directed push is defined, including the tenant ID, the number of hosts, the number of hosts reinforced with different specifications, and the detection time.

In the embodiments of the present disclosure, a host security detection and reinforcement model based on the cloud center carrier service is proposed based on the concepts of the globalization and the centralization, and the related definition and constraint are performed on the model by using normalized semantics, to implement the security detection, the data collection, and the security reinforcement of the categories of hosts under multiple nodes and the host belonging to the custom category, by the single tenant. Moreover, the number and categories of the hosts of the tenant may be dynamically expanded, and the host security may be uniformly managed and detected.

In the embodiments of the present disclosure, the security module sub-capabilities and security capability categories are uniformly orchestrated, and are expanded in sequence according to the specification levels. The security service capabilities are integrated and managed in the cloud center carrier, and the corresponding level permissions are maintained and managed to implement the unified service of the security capabilities to the outside world. Other categories of host security capabilities may be dynamically added and deleted, and the horizontal expansion of the service capabilities is possible.

In the embodiments of the present disclosure, the providing of the carrier service has centralization and globalization, so that the service capability cluster has unified management and unified state monitoring in resource management. Moreover, the statistical analysis field corresponding to the security report for the tenant is defined, so that the security data of all tenants may be processed and analyzed at the operation and maintenance side, and the regular push of the security reports to the tenant is also implemented.

The advantages of the embodiments of the present disclosure are as follows.

For the first advantage, the formative semantic definition is used for designing a host security unified detection model under the cloud security center carrier service. The tenant only needs to configure the specification permission once, and then the tenant may use the corresponding cloud center capability services, and the host assets under multiple nodes and the tenant custom host asset are supported, and the dynamic extension and reduction may be performed on the asset statistics.

For the second advantage, through performing the capability orchestration on the security sub-capability modules, a unified capability output is provided externally. The security capability service may be provided and used according to the requirements, and the corresponding security prevention and security reinforcement are performed according to the security state of the tenant host itself.

For the third advantage, in the management of the cloud center carrier service, the resource management, the security data management, and the tenant resource security report generation are uniformly maintained in central cluster, which may implement multi-node dynamic asset expansion and the horizontal expansion of the central service.

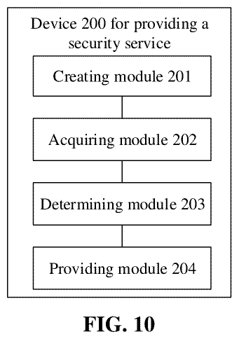

In the embodiments of the present disclosure, with reference to FIG. 10, a device 200 for providing a security service is provided. The device 200 includes a creating module 201, an acquiring module 202, a determining module 203, and a providing module 204.

The creating module 201 is configured to create a host security model under the constraint of normalized statements.

The acquiring module 202 is configured to acquire host information for a tenant, where the host information at least includes: order information of a host and asset information of the host.

The determining module 203 is configured to input the host information into the security model to obtain security service information outputted by the security model.

The providing module 204 is configured to provide, based on the security service information, a security service corresponding to the security service information to the host of the tenant.

In the embodiments of the present disclosure, the determining module being configured to input the host information into the security model includes: the determining module is configured to: input the order information represented by a first normalized statement into the security model, and/or, input the asset information represented by a second normalized statement into the security model.

In the embodiments of the present disclosure, the order information at least includes: a value of Global Order (GO) constraining whether the tenant orders a global service, where if the value of the GO is a first value, indicating that the tenant orders the security service, and if the value of the GO is a second value, indicating that the tenant does not order the security service; and a value of Ln constraining a level of the security service ordered by the tenant, where n represents that the security service ordered by the tenant belongs to a n-th level, and n is configured to determine a number of categories of modules providing the security service.

In the embodiments of the present disclosure, the asset information includes: a set of assets of multiple hosts to be maintained.

In the embodiments of the present disclosure, the determining module is further configured to: input the host information into the security model, to obtain the security service information outputted by the security model and represented by a third normalized statement.

In the embodiments of the present disclosure, the providing module is further configured to: obtain, based on the security service information, a combination of a number of categories of security service modules when the tenant orders the security service under a global service; and provide, according to the combination of the number of categories of the security service modules, a corresponding security service to the host of the tenant.

In the embodiments of the present disclosure, a device is provided, and the device includes: a processor; and a memory configured to store instructions executable by the processor.

Herein, the processor is configured to implement the operations of the above method for providing the security service when executing the computer service.

It will be appreciated by those of ordinary skill in the art that all or a portion of the operations of the above-described method embodiments may be implemented by means of hardware associated with program instructions. The above-described program may be stored in a computer-readable storage medium. The program, when executed, causes the hardware to perform the operations of the above-described method embodiments. The storage medium includes various media capable of storing program codes, such as a removable storage device, a Read-Only Memory (ROM), a Random Access Memory (RAM), a magnetic disk, or an optical disk.

In the embodiments of the present disclosure, there is provided a medium having stored thereon computer executable instructions that, when executed by a processor, cause the processor to perform the operations in the method for providing the security service as described above.

Alternatively, if the integrated modules in the embodiments of the present disclosure are realized in the form of a software functional unit and sold or used as an independent product, it can be stored in a computer readable storage medium. Based on such understanding, the technical solutions in the embodiments of the present disclosure in essence or part of the technical solutions in the embodiments of the present disclosure that contribute to the related arts can be embodied in the form of a software product which is stored in a storage medium and includes several instructions to enable a computer device (which can be a personal computer, a server, a network device, or the like) to perform all or part of the operations of the method according to each embodiment of the present disclosure. The aforementioned storage media include: a mobile storage device, a ROM, a RAM, a magnetic disk or optical disk and other media that can store program code.

The above is only the specific embodiments of the present disclosure, but the scope of protection of the present disclosure is not limited to this. Any changes or replacements that can easily be thought of by a person skilled in the art within the technical scope of the present disclosure shall be covered in the scope of protection of the present disclosure. Therefore, the protection scope of the present disclosure shall be subject to the protection scope of the claims.

### INDUSTRIAL PRACTICABILITY

The embodiments of the present disclosure discloses a method for providing a security service, which includes that a host security model is created under the constraint of normalized statements; host information is inputted into the security model, to obtain security service information outputted by the security model; and a security service corresponding to the security service information is provided, based on the security service information, to a host of a tenant. Compared with the related art where a single order for security service is performed for a single resource pool, with the single resource pool being independent, having no statistical security capability, and being unable to provide appropriate global security services on demand, the security model in the embodiments of the present disclosure can output the security service information based on the order information and the asset information of the host of the tenant, and provide corresponding security services to the host of the tenant on demand.

1. A method for providing a security service, performed by an electronic device, comprising:
creating a host security model under the constraint of custom normalized statements;
acquiring host information for a tenant, wherein the host information at least comprises: order information of a host and asset information of the host;
inputting the host information into the security model, for the security model to output security service information required by the host; and
providing, based on the security service information, security protection and reinforcement corresponding to the security service information to the host of the tenant.

2. The method for providing the security service of claim 1, wherein inputting the host information into the security model comprises at least one of:
inputting the order information represented by a first normalized statement into the security model;
or
inputting the asset information represented by a second normalized statement into the security model.

3. The method for providing the security service of claim 1, wherein the order information at least comprises:
a value of Global Order (GO) constraining whether the tenant orders a global service, wherein in response to the value of the GO being a first value, indicating that the tenant orders the security service; and in response to the value of the GO being a second value, indicating that the tenant does not order the security service; and
a value of Ln constraining a level of the security service ordered by the tenant, wherein n represents that the security service ordered by the tenant belongs to a n-th level, and n is configured to determine a number of categories of modules providing the security service.

4. The method for providing the security service of claim 1, wherein the asset information comprises:
a set of assets of a plurality of hosts to be maintained.

5. The method for providing the security service of claim 1, wherein inputting the host information into the security model, for the security model to output the security service information required by the host further comprises:
inputting the host information into the security model, to obtain the security service information outputted by the security model and represented by a third normalized statement.

6. The method for providing the security service of claim 5, wherein providing, based on the security service information, the security protection and reinforcement corresponding to the security service information to the host of the tenant comprises:
obtaining, based on the security service information, a combination of a number of categories of security service modules when the tenant orders the security service under a global service; and
providing, according to the combination of the number of categories of the security service modules, corresponding security protection and reinforcement to the host of the tenant.

7. An electronic device, comprising:
a processor; and
a memory for storing computer programs that, when executed by the processor, cause the processor to:
create a host security model under the constraint of custom normalized statements;
acquire host information for a tenant, wherein the host information at least comprises: order information of a host and asset information of the host;
input the host information into the security model for the security model to output security service information required by the host; and
provide, based on the security service information, security protection and reinforcement corresponding to the security service information to the host of the tenant.

8. The electronic device of claim 7, wherein the processor is configured to perform at least one of:
inputting the order information represented by a first normalized statement into the security model;
or
inputting the asset information represented by a second normalized statement into the security model.

9. (canceled)

10. A non-transitory computer-readable storage medium having stored thereon computer executable instructions that, when executed by a processor, cause the processor to perform the following operations of:
creating a host security model under the constraint of custom normalized statements;
acquiring host information for a tenant, wherein the host information at least comprises: order information of a host and asset information of the host;
inputting the host information into the security model, for the security model to output security service information required by the host; and
providing, based on the security service information, security protection and reinforcement corresponding to the security service information to the host of the tenant.

11. The non-transitory computer-readable storage medium of claim 10, wherein the security model outputs the corresponding security service information without occupying resources of the host of tenant, and is able to perform adaptive expansion and policy updates on security risks of the host of the tenant.

12. The non-transitory computer-readable storage medium of claim 10, wherein inputting the host information into the security model comprises at least one of:
inputting the order information represented by a first normalized statement into the security model;
or
inputting the asset information represented by a second normalized statement into the security model.

13. The non-transitory computer-readable storage medium of claim 10, wherein the asset information comprises: a set of assets of a plurality of hosts to be maintained; and
wherein the order information at least comprises:
a value of Global Order (GO) constraining whether the tenant orders a global service, wherein in response to the value of the GO being a first value, indicating that the tenant orders the security service; and in response to the value of the GO being a second value, indicating that the tenant does not order the security service; and
a value of Ln constraining a level of the security service ordered by the tenant, wherein n represents that the security service ordered by the tenant belongs to a n-th level, and n is configured to determine a number of categories of modules providing the security service.

14. The non-transitory computer-readable storage medium of claim 10, wherein inputting the host information into the security model, for the security model to output the security service information required by the host further comprises:
inputting the host information into the security model, to obtain the security service information outputted by the security model and represented by a third normalized statement.

15. The non-transitory computer-readable storage medium of claim 14, wherein providing, based on the security service information, the security protection and reinforcement corresponding to the security service information to the host of the tenant comprises:
obtaining, based on the security service information, a combination of a number of categories of security service modules when the tenant orders the security service under a global service; and
providing, according to the combination of the number of categories of the security service modules, corresponding security protection and reinforcement to the host of the tenant.

16. The method for providing the security service of claim 1, wherein the security model outputs the corresponding security service information without occupying resources of the host of tenant, and is able to perform adaptive expansion and policy updates on security risks of the host of the tenant.

17. The electronic device of claim 7, wherein the order information at least comprises:
a value of Global Order (GO) constraining whether the tenant orders a global service, wherein in response to the value of the GO being a first value, indicating that the tenant orders the security service; and in response to the value of the GO being a second value, indicating that the tenant does not order the security service; and
a value of Ln constraining a level of the security service ordered by the tenant, wherein n represents that the security service ordered by the tenant belongs to a n-th level, and n is configured to determine a number of categories of modules providing the security service.

18. The electronic device of claim 7, wherein the asset information comprises:
a set of assets of a plurality of hosts to be maintained.

19. The electronic device of claim 7, wherein the processor is configured to:
input the host information into the security model, to obtain the security service information outputted by the security model and represented by a third normalized statement.

20. The electronic device of claim 19, wherein the processor is configured to:
obtain, based on the security service information, a combination of a number of categories of security service modules when the tenant orders the security service under a global service; and
provide, according to the combination of the number of categories of the security service modules, corresponding security protection and reinforcement to the host of the tenant.

21. The electronic device of claim 7, wherein the security model outputs the corresponding security service information without occupying resources of the host of tenant, and is able to perform adaptive expansion and policy updates on security risks of the host of the tenant.
